(19) United States
(12) Patent Application Publication
(10) Pub. No.: US 2008/0163495 A1
(43) Pub. Date: Jul. 10, 2008

(54) Hair Clipper With Motorised Cutting Guide

(75) Inventor: Olivier Smal, Magnee (BE)

Correspondence Address: REINHART BOERNER VAN DEUREN P.C., 2215 PERRYGREEN WAY, ROCKFORD, IL, 61107, US

(73) Assignee: FACO S. A., Wandre (BE)

(21) Appl. No.: 11/994,729

(22) PCT Filed: Jun. 20, 2006
(86) PCT No.: PCT/BE2006/000069

§ 371 Date: Jan. 4, 2008

(30) Foreign Application Priority Data
Jul. 7, 2005 (EP) 05447164.4

(51) Int. Cl. B26B 19/00

(52) U.S. Cl. 30/202; 30/201; 30/233

(57) ABSTRACT

The invention concerns a hair clipper comprising a device for adjusting the position of a powered cutting guide slaved to an electronic device, automatically adapting the position of said cutting guide based on the option selected by the user.

### FIELD OF THE INVENTION

The present invention relates to the area of hairdressing, and in particular to hair clippers having a cutting guide with motorised regulation and driven by a program providing the user with different cutting options.

### STATE OF THE ART

Hair clippers with cutting guides allowing to manually regulate the length of cut of the hair are well known from the state of the art. These are usually a guide that the user positions once and for all to a given length of hair, which often remains constant during the entire haircut. The cutting guide is moreover mainly intended for non-professional users who generally find it difficult to estimate the length of cut required on the different parts of the scalp.

### AIMS OF THE INVENTION

The present invention aims to provide a clipper having a motorised cutting guide with instructions that allows to automatically adapt the position of the cutting guide depending on the part of the scalp to be processed by means of an electronic device (microprocessor or simply a circuit comprising at least a transistor and/or a diode) for adapting the position of the cutting guide to the part of the scalp processed by the user.

### SUMMARY OF THE INVENTION

The present invention discloses a hair clipper with a device for regulating the position of a cutting guide, motorised and driven by an electronic device, which automatically adapts the position of said cutting guide depending on the cutting option selected by the user.

According to the invention, the electronic device is a circuit comprising a transistor and/or a diode.

The clipper preferably comprises pictograms showing the user the options for different haircuts.

As an advantage, said regulation device is incorporated into the housing of said hair clipper.

In addition, said device comprises a shaft connecting said cutting guide to the motor.

The shaft is preferably a worm screw.

### BRIEF DESCRIPTION OF THE FIGURES

FIG. 1 shows the sketch of a motorised cutting guide incorporated into a clipper.

FIG. 2 shows the instructions and the possible options for the user.

FIG. 3 shows an operation chart of the microprocessor in manual or automatic mode depending on the options selected by the user.

FIG. 4 shows the profile view of a motorised cutting guide incorporated into a clipper.

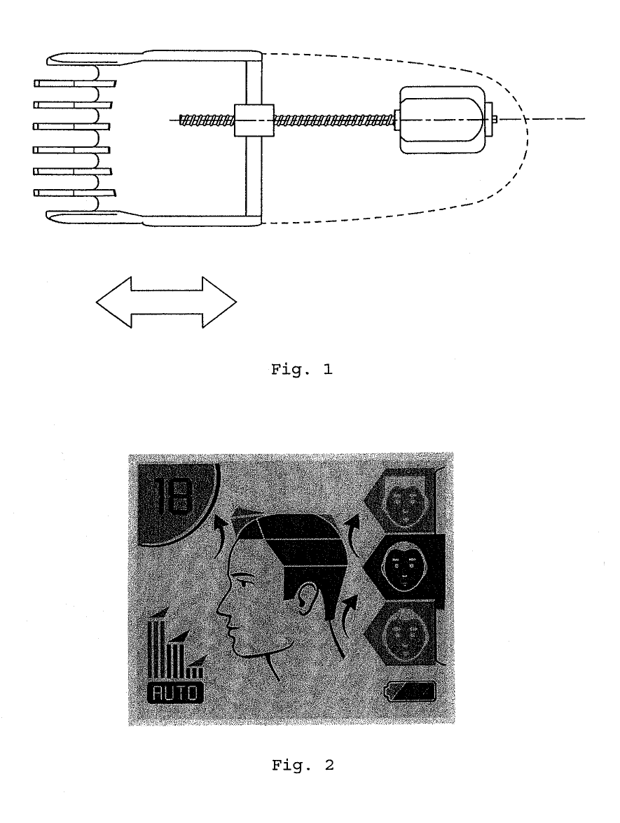

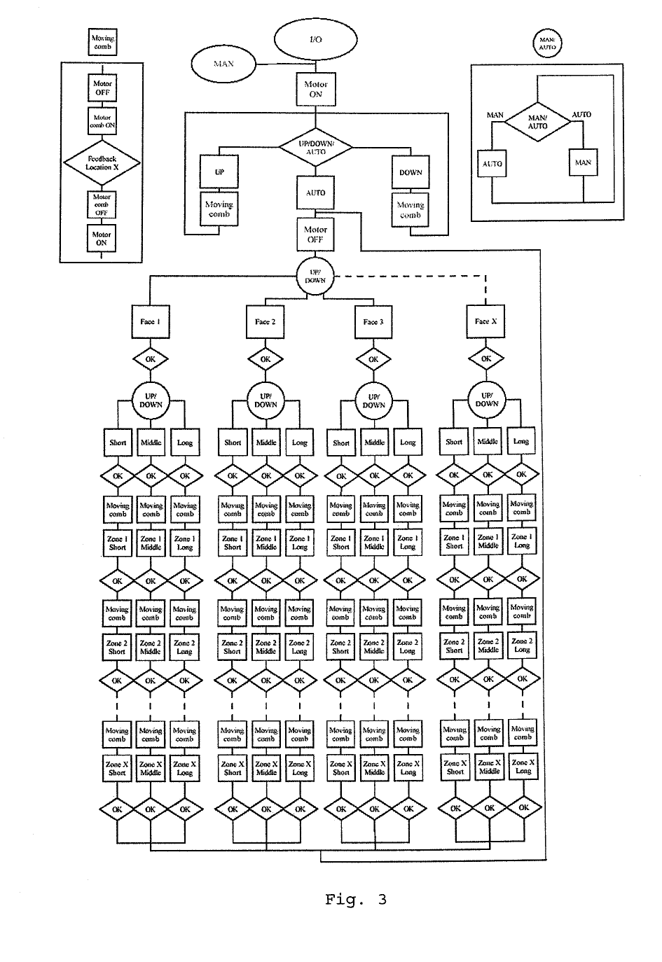

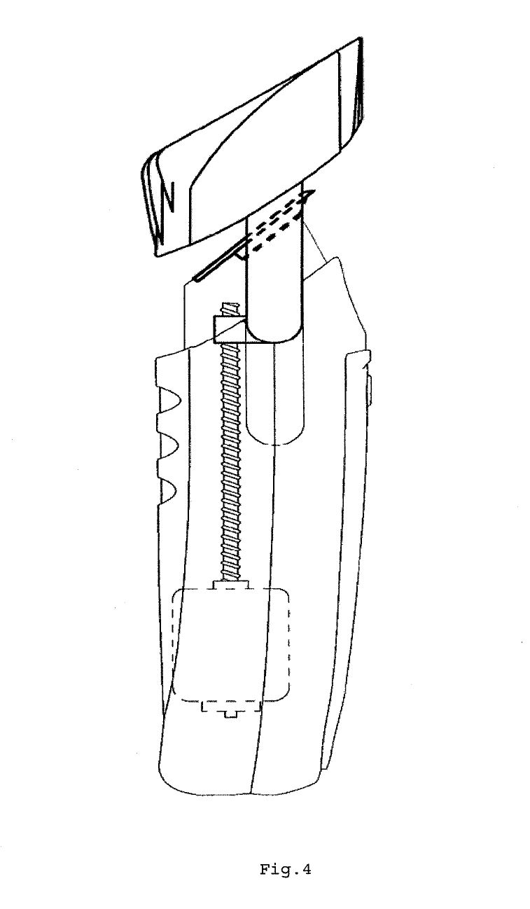

### DETAILED DESCRIPTION OF THE INVENTION

The motorised cutting guide of the present invention is intended to simplify the use of hair clippers for non-professional users. Inside the housing, it comprises a motor connected by a shaft to the cutting guide. The cutting guide is driven by a program available via a microprocessor suggesting various options to the user.

The options suggested to the user are the manual mode and the automatic mode. The manual mode is set by default and the user selects the length of cut by means of the “UP” and “DOWN” buttons. The motorised cutting guide then automatically shifts to the desired position.

In the automatic mode, the clipper provides the user with various haircut options symbolised by pictograms (see FIG. 2). The user selects the average height of this cut, for example short, medium or long. Lastly, the clipper shifts the cutting guide to the desired height and displays the area of the scalp to be processed. This operating mode allows many combinations of length of haircut, providing many possible hairstyles.

1. Hair clipper with a device for regulating the position of a cutting guide, motorised and driven by an electronic device which automatically adapts the position of said cutting guide depending on the cutting option selected by the user.

2. Hair clipper as in claim 1, wherein said electronic device comprises a circuit with a transistor and/or a diode.

3. Hair clipper as in claim 1, wherein said clipper comprises pictograms showing the user the options for different haircuts.

4. Hair clipper as in claim 1, wherein said regulation device is incorporated into the housing of said hair clipper.

5. Hair clipper as in claim 1, wherein said device comprises a shaft connecting said cutting guide to the motor.

6. Hair clipper as in claim 5, wherein the shaft is a worm screw.
